(19) United States
(12) Patent Application Publication
(10) Pub. No.: US 2006/0053615 A1
(43) Pub. Date: Mar. 16, 2006

(54) Method for the production of an air restrictor and machine incorporating the air restrictor

(75) Inventors: Andre Kreller, Wiesloch (DE); Andreas Muller, Heidelberg (DE); Matthias Schuster, Heidelberg (DE); Monika Blumm, Wiesloch (DE); Andreas Detloff, Walldorf (DE); Michael Pasuch, Walldorf (DE); Ludwig Reinhard, Heidelberg (DE); Frank Schaum, Neckargemund (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/225,801

(22) Filed: Sep. 13, 2005

(30) Foreign Application Priority Data
Sep. 13, 2004 (DE) 10 2004 044 124.3

(51) Int. Cl. B32B 37/00; B23K 31/02; B29C 65/00; B23P 25/00; B31B 1/60

(52) U.S. Cl. 29/458; 156/60; 156/252; 228/256; 29/527.2

(57) ABSTRACT

In a method for producing an air restrictor, use is made of at least one liquid or tacky substance to join perforated plates to one another and to seal the air restrictor. The substance can be, for example, an adhesive contained in capsules. The adhesive is liberated by bursting the capsules inserted between the perforated plates.

### BACKGROUND OF THE INVENTION

Field of the Invention

The present invention relates to a method for the production of an air restrictor having joined perforated plates.

Published, non-prosecuted German patent application DE 44 06 739 A1 (corresponding to U.S. Pat. No. 5,505,124) describes an air restrictor without further information about its production.

### SUMMARY OF THE INVENTION

It is accordingly an object of the invention to provide a method for the production of the air restrictor in large numbers and to a machine incorporating such an air restrictor that overcome the above-mentioned disadvantages of the prior art devices and methods of this general type, in which an optimal restrictive effect is also ensured.

The method according to the invention relates to the production of an air restrictor where perforated plates are joined together. The invention is characterized in that at least one liquid or tacky substance is used for joining the perforated plates to one another and/or for sealing the air restrictor. In this case, the substance can be used for joining the perforated plates and/or for sealing off the air restrictor.

A development of the method according to the invention includes soldering the perforated plates to one another and the substance being a liquefied solder material. In this case, the solder material is used both to join the perforated plates and to seal the air restrictor.

In a further development, the perforated plates are adhesively bonded to one another and the substance is an adhesive. In this case, the adhesive can be contained in capsules and can be liberated by bursting the capsules, inserted between the perforated plates. Instead, the adhesive can also be contained on both sides of an adhesive film and the adhesive film can be inserted between the perforated plates. In both cases, the substance, that is to say the adhesive, is not just used to join the perforated plates to one another but also to seal the air restrictor.

According to a further development, the substance is a liquid in which there are particles for joint sealing. In this case, the particle-containing liquid is used only to seal the air restrictor and the perforated plates can be joined to one another by the adhesive in the capsules or on the adhesive film or by a solder material or by screw fixings.

In a further development, at least one of the perforated plates has lands with a land width of less than 1.0 millimeter between the holes. The land width is preferably less than 0.5 millimeter. As a result, an interior of the air restrictor which is organized in an extremely fine structure in which vortex chambers can be produced, which, just like its sealing, is important for an optimal restrictive effect.

The invention also includes a sheet brake for braking sheets of a printing material, which sheet brake contains at least one air restrictor which has been produced according to the method of the invention or in accordance with one of its developments. Furthermore, the invention also includes a sheet deliverer that is equipped with the aforesaid sheet brake, and a machine for processing the sheets of printing material that contain the sheet deliverer. The aforesaid machine is preferably a press.

Other features which are considered as characteristic for the invention are set forth in the appended claims.

Although the invention is illustrated and described herein as embodied in a method for the production of an air restrictor and a machine incorporating the air restrictor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a diagrammatic, exploded, perspective view of perforated plates to be soldered to each other according to a first exemplary embodiment of the invention;

FIG. 1B is a diagrammatic, enlarged plan view of a first perforated plate;

FIG. 2 is a sectional view of the perforated plate in a solder container;

FIGS. 3-5 are diagrammatic, sectional views of multiple perforated plates for explaining a method of construction;

FIG. 6 is a diagrammatic, exploded, perspective view of perforated plates to be soldered to each other according to a second exemplary embodiment of the invention;

FIGS. 7-10 are diagrammatic, sectional views of the second exemplary embodiment, in which the perforated plates are adhesively bonded to one another by adhesive capsules;

FIG. 11 is a diagrammatic, exploded, perspective view of a third exemplary embodiment, in which the adhesive plates are adhesively bonded to one another by adhesive films;

FIGS. 12-14 are diagrammatic, sectional views of the third exemplary embodiment, in which the adhesive plates are adhesively bonded to one another by adhesive films;

FIGS. 15 and 16 are diagrammatic, sectional views showing the sealing of gaps possibly still present between the perforated plates, carried out by use of a sealing liquid, at their joining points following the joining of the perforated plates;

FIG. 17 is a diagrammatic, perspective view of a sheet brake having supporting units which contain air restrictors produced in accordance with the invention; and

FIG. 18 is a diagrammatic, side-elevational view of a sheet-fed press equipped with the sheet brake from FIG. 17.

### DESCRIPTION OF THE PREFERRED EMBODIMENTS

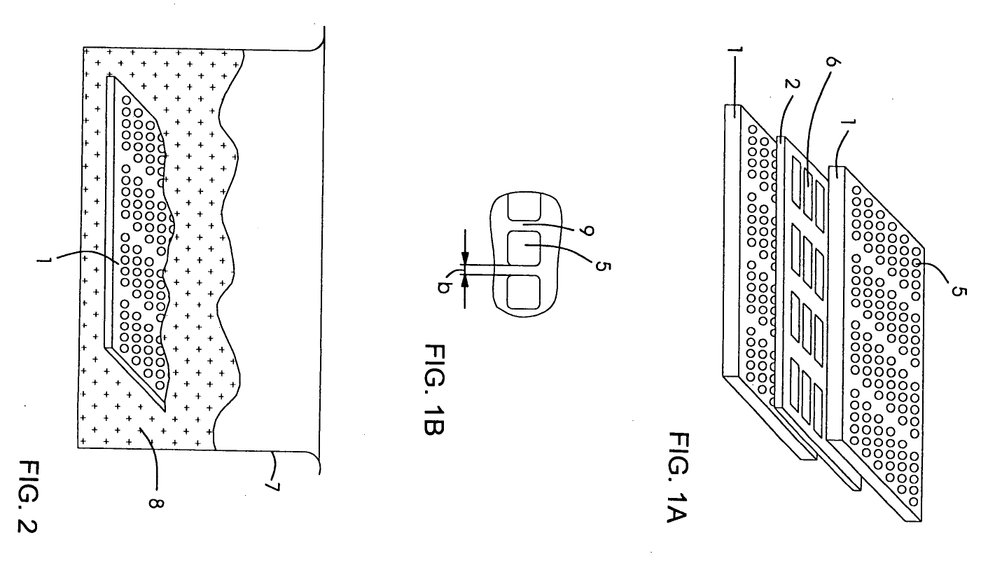

In all the figures of the drawing, sub-features and integral parts that correspond to one another bear the same reference symbol in each case. Referring now to the figures of the drawing in detail and first, particularly, to FIG. 1A thereof, there is shown first perforated plates 1 and a second perforated plate 2, which are joined together in accordance with a production method which is explained below to form an air restrictor. The first perforated plates 1 have small holes 5, and the second perforated plate 2 has, by contrast, large holes 6. The small and large holds 5, 6 are passage holes and are disposed in mutually corresponding, regular hole patterns. The number of small holes 5 is greater in each first perforated plate 1 than the number of large holes 6 in the second perforated plate 2. The first and the second perforated plates 1, 2 have a plate thickness that is 0.05 millimeter to 2.00 millimeter, the second perforated plate 2 being thinner than the first perforated plates 1. In addition, each first and the second perforated plate 1, 2 is formed as a metal sheet.

FIG. 1B shows, by using an enlargement, that between the small holes 5 there are lands 9 whose land width b is less than 1.0 millimeter, preferably less than 0.5 millimeter and, for example, less than 0.3 millimeter. Such very fine lands 9 are advantageous for a high packing density and an optimal restrictive action.

FIG. 2 shows a solder container 7 with a solder bath 8 kept liquid by heat, into which the first perforated plates 1 are dipped one after another so that, following removal from the solder bath 8, they are each coated on both sides of the plate with a solder film, which hardens on the first perforated plates 1.

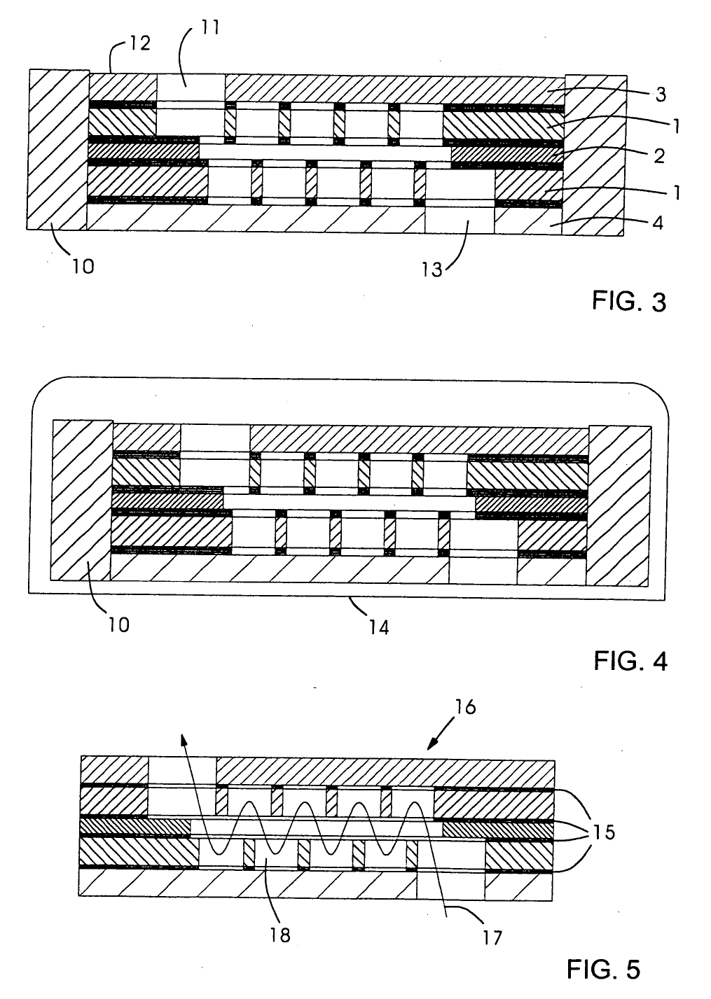

FIG. 3 shows a further production step, in which the first perforated plates 1, the second perforated plate 2, a third perforated plate 3 and a fourth perforated plate 4 are positioned on one another in a sandwich configuration while striking a positioning device 10. The plate thicknesses of the third and fourth perforated plate 3, 4 in each case are in the dimensional range already indicated for the other perforated plates 1, 2. The third perforated plate 3 has an air outlet 11, from which the restricted air immerges, and forms a nozzle surface 12 for the pneumatic guidance of the printing material sheet. The fourth perforated plate 4 has an air inlet 13 for the blown air to be restricted. The second perforated plate 2 is disposed between the first perforated plates 1 in order to form a plate pack that is in turn disposed between the third and fourth perforated plates 3, 4. In this case, the second, third and fourth perforated plates 2, 3, 4 are in the state still free of the solder material.

FIG. 4 shows a following method step, in which all the perforated plates 1 to 4 stacked on one another and pressed, together with the positioning device 10, are placed in a soldering oven 14 or moved through the latter, which soldering oven 14 liquefies the solder film on the first perforated plates 1 again, so that the solder film is joined to the second, third and fourth perforated plates 2, 3, 4.

FIG. 5 shows the perforated plates 1 to 4 in the state firmly soldered to one another after renewed solidification of the solder film, the perforated plates 1 to 4 already having been removed from the soldering oven 14 and the positioning device 10. In this state, the lands 9 of the first perforated plates 1 are joined to lands between the large holes 6 of the second perforated plates 2 and to the third and fourth perforated plates 3, 4 via gas-tight and air-tight solder joints 15. In the air restrictor 16 resulting from this, a plurality of small holes 5 are overlapped by each large hole 6, so that the result is a substantially meandering flow path 17 of the blown air with air vortices in vortex chambers 18 of the air restrictor 16 formed in the manner of a labyrinth on the inside.

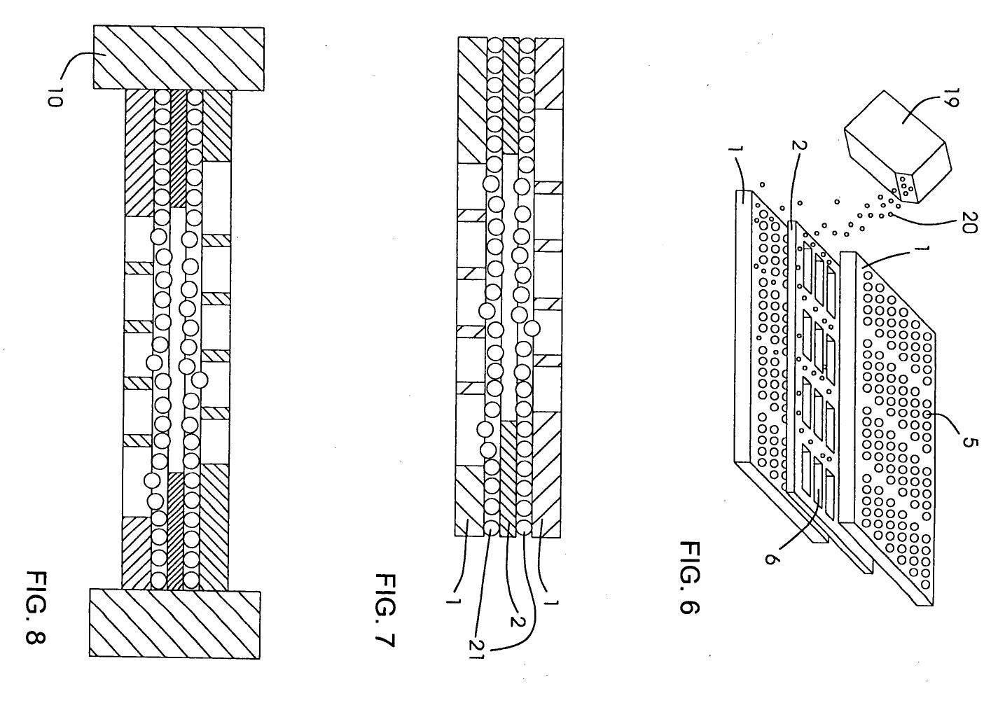

FIG. 6 shows the perforated plates 1, 2 already described in connection with FIG. 1A as starting materials for a joining method alternative to soldering. In this joining method, the perforated plates 1, 2 can be formed not only of metal but instead also of a plastic or another nonmetallic material. By use of a scattering apparatus 19, capsules 20 filled with adhesive are introduced between the second perforated plate 2 and the first perforated plates 1.

FIG. 7 shows that, after the perforated plates 1, 2 have been stacked on one another without any pressure, the capsules 20 in each plate region form adhesive layers 21 that are still inactivated. As yet, none of the capsules 20 has been burst and liberated its adhesive.

FIG. 8 shows that a plate pack formed by the perforated plates 1, 2 and inactivated adhesive layers 21 is inserted into the positioning device 10 in order to align the extremely fine hole pattern of the first perforated plates 1 exactly relative to the somewhat less fine hole pattern of the second perforated plate 2.

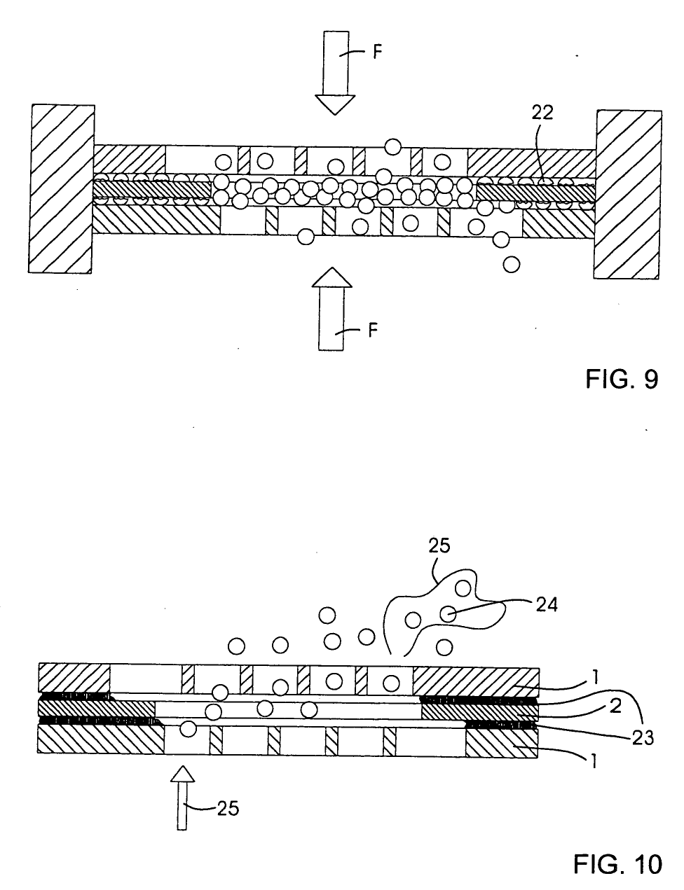

FIG. 9 shows that, in a following step, the plate pack within the positioning device 10 is acted on with a force F (and an opposing force), only those capsules 20 being caused to burst and, as a result, to liberate the adhesive, which are located outside the region of the small and large holes 5, 6 and thus between plate surfaces pressed against one another. Only the capsules 22 that have burst thereafter have been subjected to a plate pressure on one side and liberate their adhesive.

FIG. 10 shows that, as a result, the perforated plates 1, 2 are firmly adhesively bonded to one another and sealed by activated adhesive layers 23 formed by the adhesive from the burst capsules 22, and the remaining, unburst capsules 24 are blown or rinsed out of the plate composite through the holes 5, 6 by use of a gaseous (e.g. compressed air) or liquid (e.g. water) fluid 25. The drawing does not show that the plate composite containing the inner perforated plates 1, 2 is likewise adhesively bonded to the outer perforated plates 3, 4 (see FIG. 3) by the capsules 20 to form the finished air restrictor to 16, which appears as illustrated in FIG. 5. The activated adhesive layers 23 isolate the restrictor nozzles opening beside one another into the nozzles surface 12 in a gas-tight and air-tight manner in exactly the same way as the soldered joints 15 of the exemplary embodiment previously described are able to do.

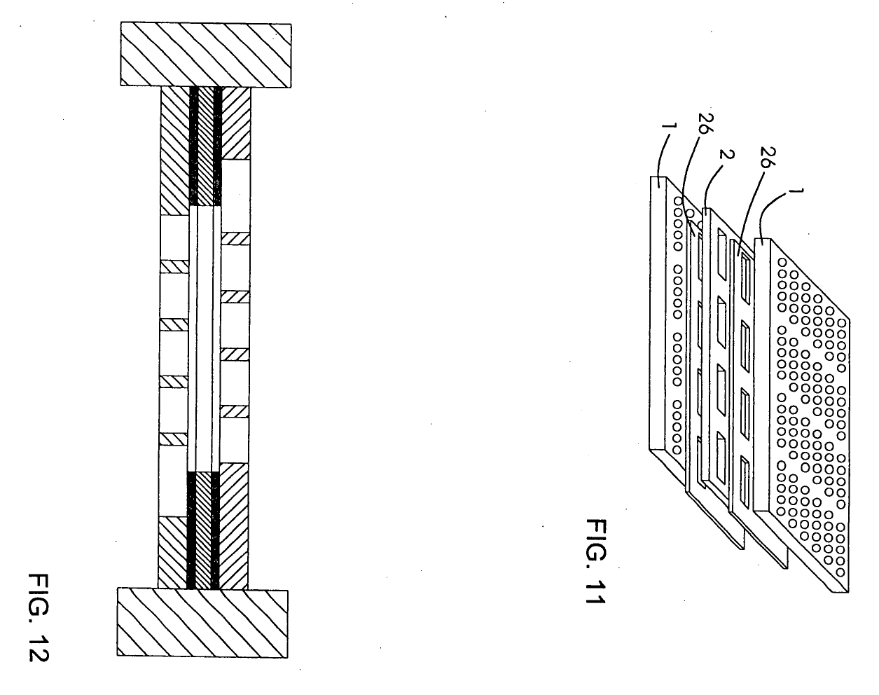

FIG. 11 shows the perforated plates 1, 2 already described in conjunction with FIG. 1A together with in each case double-sided adhesive films 26 as starting materials for an alternative adhesive bonding method. Each adhesive film 26 has a film thickness of 0.01 millimeter to 0.20 millimeter and inner and outer contouring which is substantially congruent with the second perforated plate 2. The adhesive films 26 therefore have a hole pattern which is substantially congruent with the large holes 6 in the second perforated plate 2.

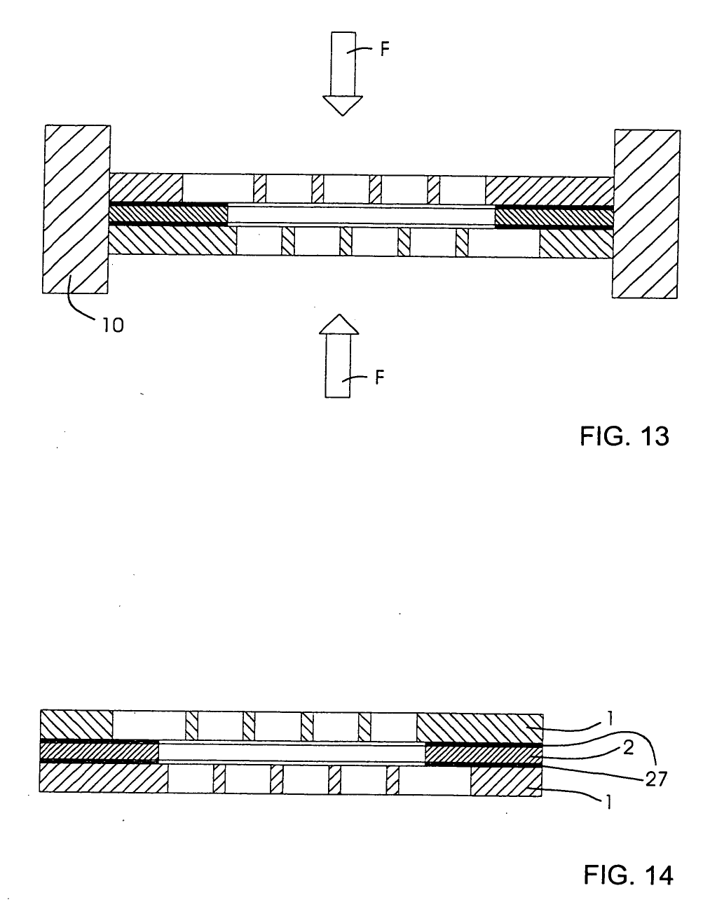

FIG. 12 shows that the perforated plates 1, 2 and the adhesive films 26 are stacked in the positioning device 10 to form a pack which, according to FIG. 13, is pressed together by the force F, so that, following its removal from the positioning device 10, it has gas-tight and air-tight adhesive bonds 27 which are provided by the adhesive films 26, as illustrated in FIG. 14. By the bonds 27, the perforated plates 1, 2 are joined firmly to one other. The drawing does not show that the pack containing the inner perforated plates 1, 2 and the adhesive films 26 inserted between them, are likewise adhesively bonded to the outer perforated plates 3, 4 (see FIG. 3) by further such double-sided acting adhesive films to form the finished restrictor, which appears as illustrated in FIG. 5. The further adhesive films each have a hole pattern which is substantially congruent with the small holes 5 of the first perforated plates 1. The use of all the adhesive films for bonding the perforated plates 1 to 4 permits them to be formed not only as metal sheets but also from a nonmetallic material, for example plastic.

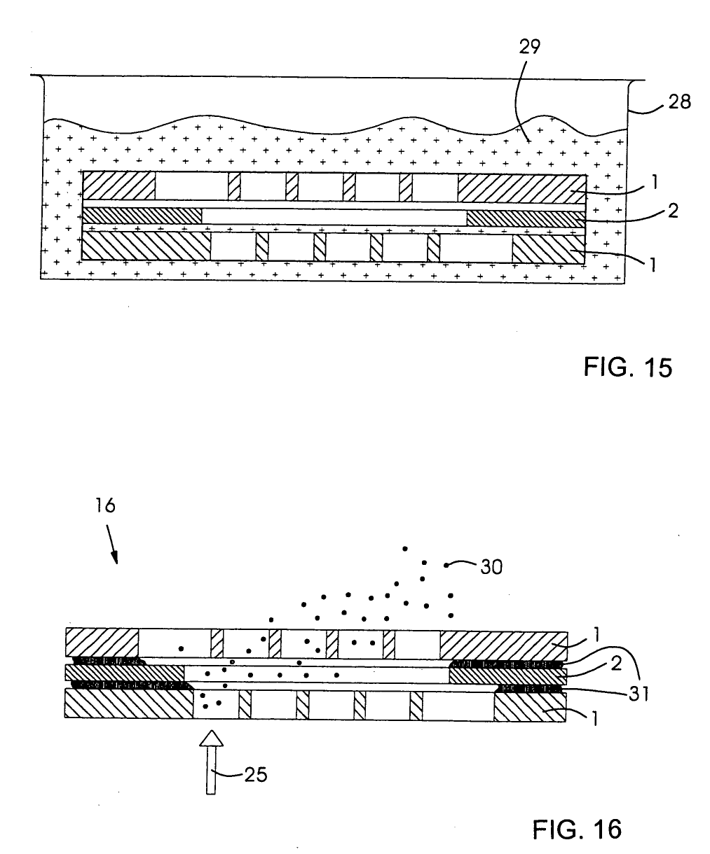

FIG. 15 shows a sealing agent container 28 having a sealing agent bath 29, which is formed of a liquid with microscopically fine synthetic plastic particles contained therein, whose task is to settle in gaps and, as a result, to close the latter permanently. A sealing liquid of this type is offered, for example, by the company Adolf Würth GmbH, Germany, under the trade name “Kühlerdicht” [radiator sealer] for sealing leaks in automobile radiators. The plate stack containing the first perforated plates 1 and the second perforated plate 2 and, if appropriate, also the third and fourth perforated plates 3, 4 (not illustrated in the drawing of FIG. 15), whose perforated plates have already been joined firmly to one another by the soldiering method (see FIGS. 1A to 4) or one of the adhesive bonding methods (see FIGS. 6 to 10 or 11 to 14) or by screw fixings, are dipped into the sealing agent 29 for some time and, if appropriate, moved in the latter for the purpose of better distribution of the particles. The aforesaid particles settle between the perforated plates 1, 2 in the interspaces located outside the small and large holes 5, 6, for example at locations where the adhesive bonding or soldering is incomplete or damaged or, for example in the case of screw fixing, the perforated plates do not rest sufficiently closely against one another. Following the removal of the plate stack from the sealing agent 29, the liquid from the plate stack is evaporated or volatilized.

FIG. 16 shows that, after that, residual particles 30 that have not settled in the gaps between the perforated plates 1, 2 of the air restrictor 16 are blown out or rinsed out from the plate stack by the fluid 25 already mentioned. The particles remaining in the plate stack and inlaid in its gaps form substantially gas-tight and air-tight sealing agent layers 31.

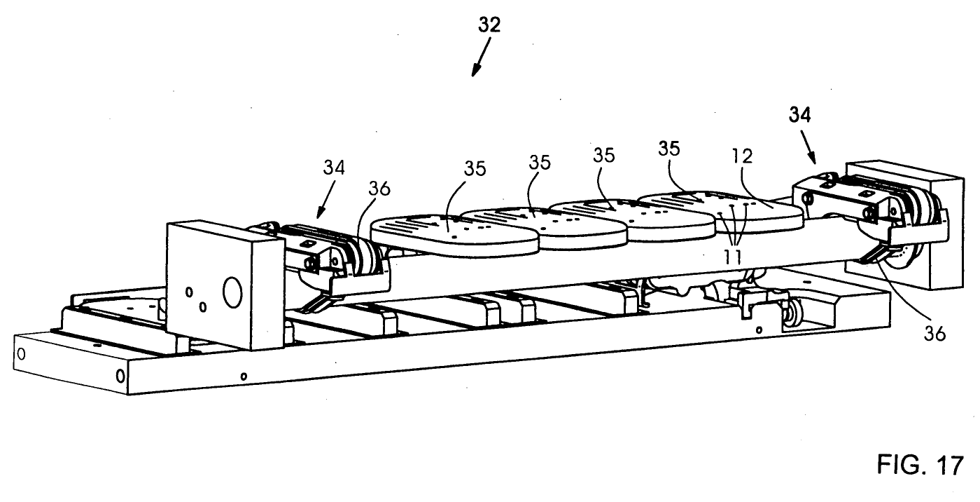

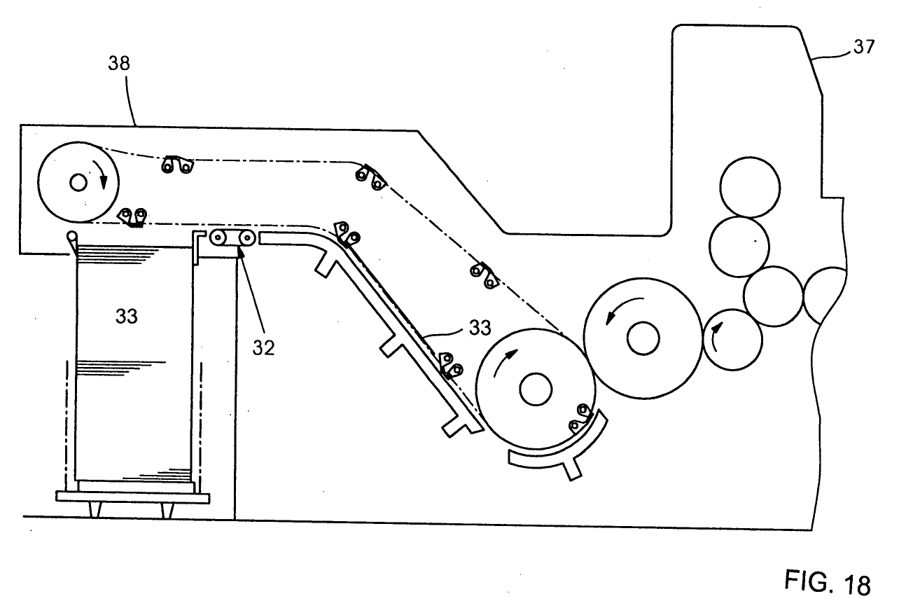

FIG. 17 shows a sheet brake 32 for braking sheets 33 of printing material (see FIG. 18).

The sheet brake 32 contains braking units 34 and supporting units 35 disposed between the latter. The braking units 34 each have at least one circulating braking element 36, which is a braking roll or disk or preferably a braking tape or belt. The supporting units 35 are each equipped with the aforesaid nozzle surface 12 for the support, carried out by an air cushion or the pneumatic support, of the sheet 33 to be braked. The air outlets 11 open in the nozzle surface 12 as what are known as restrictor nozzles. Integrated into each supporting unit 35 is a large number of air restrictors 16 produced in accordance with one of the methods illustrated in FIGS. 1 to 16.

FIG. 18 shows a machine 37 for processing the sheets 33. The machine 37 is a press, preferably a perfecting press for printing on both sides of the sheets 33, and contains a sheet deliverer 38 of which the sheet brake 32 is a constituent part.

This application claims the priority, under 35 U.S.C. § 119, of German patent application No. 10 2004 044 124.3, filed Sep. 13, 2004; the entire disclosure of the prior application is herewith incorporated by reference.

We claim:

1. A method for producing an air restrictor, which comprises the steps of:
joining perforated plates to one another; and
providing at least one substance selected from the group consisting of a liquid substance and a tacky substance for at least one of joining the perforated plates to one another and sealing the air restrictor.

2. The method according to claim 1, which further comprises soldering the perforated plates to one another and the substance is a liquefied solder material.

3. The method according to claim 1, which further comprises adhesively bonding the perforated plates to one another and the substance is an adhesive.

4. The method according to claim 3, which further comprises:
providing the adhesive in capsules containing the adhesive; and
liberating the adhesive by bursting the capsules contained between the perforated plates.

5. The method according to claim 3, further comprising inserting an adhesive film between the perforated plates, the adhesive being contained on both sides of the adhesive film.

6. The method according to claim 1, which further comprises providing the liquid substance with particles for joint sealing.

7. The method according to claim 1, which further comprises forming at least one of the perforated plates with holes and lands having a land width of less than 1.0 millimeter between the holes.

8. The method according to claim 7, which further comprises setting the land width to be less than 0.5 millimeter.

9. A machine for processing sheets of printing material, the machine comprising:
at least one air restrictor containing:
perforated plates joined to one another; and
at least one substance selected from the group consisting of a liquid substance and a tacky substance for at least one of joining said perforated plates to one another and sealing said air restrictor.

10. The machine according to claim 9, wherein the machine is a press.

11. The machine according to claim 9, further comprising a sheet brake containing said air restrictor.

12. The machine according to claim 11, further comprising a sheet deliverer containing said sheet brake.
